(19) United States
(12) Patent Application Publication
(10) Pub. No.: US 2012/0186935 A1
(43) Pub. Date: Jul. 26, 2012

(54) PERFORATED CLUTCH DISC AND HEAT MANAGEMENT METHOD

(75) Inventor: ROSS A. McCOMBS, OSKALOOSA, IA (US)

(73) Assignee: PRESTOLITE PERFORMANCE LLC, Cleveland, OH (US)

(21) Appl. No.: 13/358,805

(22) Filed: Jan. 26, 2012

Related U.S. Application Data
(60) Provisional application No. 61/436,270, filed on Jan. 26, 2011.

(51) Int. Cl. F16D 13/64; B23P 11/00

(52) U.S. Cl. 192/107 M; 192/107 R; 29/428

(57) ABSTRACT

A clutch disc for use in an automobile engine in communication with a flywheel is provided. The clutch disc includes a cylindrical disc comprising a central aperture. One or both sides of the cylindrical disc includes a clutch lining having a high coefficient of friction. The clutch lining is configured to interact with the flywheel during normal operation of an engine. The clutch disc further includes a plurality of perforations through the clutch disc, including the clutch lining and cylindrical disc. The perforations through the clutch disc provide a means for heat removal from within an engine and aid in extending the life of the clutch disc and clutch assembly.

### CROSS-REFERENCE TO RELATED APPLICATIONS

This application claims priority under 35 U.S.C. §119 of a provisional application Ser. No. 61/436,270 filed Jan. 26, 2011, which application is hereby incorporated by reference in its entirety.

### FIELD OF THE INVENTION

The present invention is related generally to an automobile engine. More particularly, but not exclusively, the invention relates to an improved clutch disc for use with a clutch assembly and flywheel that increases airflow through the clutch assembly and engine, as well as a method of making the clutch disc.

### BACKGROUND OF THE INVENTION

A conventional clutch assembly has a clutch disc (generally, a steel plate disc) with clutch lining discs (abrasive material on at least one side). A pressure plate can be moved against one side of the clutch disc to move it into abutment with an engine flywheel. The abrasive nature of the lining disc(s) and compression of the pieces together by the pressure plate induces the clutch disc to spin with the flywheel to transfer rotational motion of the flywheel, which is powered by the driving force, the crankshaft of the engine, to the clutch disc, which is connected to and turns a driven shaft, e.g. the drive shaft to the transmission that powers the driven wheel(s) of the car or truck.

The clutch assembly is positioned between the engine block and the bell housing of the transmission. The clutch assembly has a cover or housing to enclose the flywheel and clutch assembly. The cover is sometimes called a clutch hat. The cover protects the clutch and flywheel from the elements and from outside access to these fast-spinning parts.

A typical clutch disc is a substantially metal (e.g. steel) cylindrical plate that is moved into abutment with the flywheel to transfer crankshaft motion (driven shaft) to the transmission. When fully engaged, it turns with the crankshaft at motor rotations per minute (rpm), which is usually at least several thousand rpm. The shapes can vary depending on a number of factors including type and manufacturer of the motor, flywheel, or clutch. A pressure plate engages the clutch disc to move it against the flywheel, or retracts the clutch disc away from the flywheel to disengage the two. The clutch disc has a clutch lining on at least the flywheel side that is of a high coefficient of friction to engage the flywheel and to spin the clutch disc with the flywheel. Because of the frictional interaction between the clutch and the flywheel, substantial heat is generated.

Due to the heat built up between the clutch disc and flywheel in communication with the clutch disc, the clutch lining, disc, or other clutch parts can warp or deform. The warping or deforming of components of the clutch causes chatter that can degrade clutch performance. The chattering can also speed up or cause clutch failure, which requires replacement of the clutch assembly or components. The replacement of clutches can be expensive and time consuming. While money is a direct loss with replacement, the loss of the use of the automobile may also result from the clutch failure.

It is therefore a primary object, feature, and/or objective of the present invention to provide an improved clutch disc that overcomes the deficiencies in the art.

It is another object, feature, and/or objective of the present invention to provide a clutch disc that includes a heat management function to reduce the buildup of heat in a clutch assembly.

It is another object, feature, and/or objective of the present invention to provide a clutch disc that increases airflow through the clutch assembly without decreasing the functionality of the clutch disc.

It is another object, feature, and/or objective of the present invention to provide a clutch disc with removal of material to make the clutch disc lighter and improve power transfer, fuel efficiency, etc. of the automobile.

It is another object, feature, and/or objective of the present invention to provide a clutch disc that meets structural and strength criteria or exceed the same.

It is another object, feature, and/or objective of the present invention to provide a clutch disc that has flexibility in design so that by number, location, size, and shape a perforation can direct airflow or accomplish heat removal in different ways.

These and/or other objects, features, and advantages of the present invention will be apparent to those skilled in the art. The present invention is not to be limited to or by these objects, features and advantages. No single embodiment need provide each and every object, feature, or advantage.

### SUMMARY OF THE INVENTION

According to one aspect of the present invention, a clutch disc for use in an engine between a clutch assembly and a flywheel is provided. The clutch disc includes a cylindrical disc comprising a central aperture and having a flywheel side comprising a clutch lining having a high coefficient of friction, and a clutch assembly side. The clutch disc further includes a plurality of perforations through the cylindrical disc and clutch lining. The plurality of perforations is designed to increase airflow to remove heat from an area around the central aperture and within the engine.

According to another aspect of the present invention, a method of manufacturing a clutch disc is provided. The method includes providing a generally cylindrical disc having a flywheel side and a clutch assembly side. A splined central aperture having an axis is machined through the clutch disc. A clutch lining having a high coefficient of friction is operably attached to the flywheel side of the cylindrical clutch disc. A plurality of perforations is machined through the clutch lining and cylindrical disc about the axis of the central aperture, the plurality of perforations configured to increase the airflow through the clutch disc.

According to yet another aspect of the present invention, an automobile is provided. The automobile includes an engine and a driven shaft extending from the engine. A flywheel is mounted on the driven shaft and includes an engine side and a clutch side. The clutch side comprises a plurality of fins positioned adjacent an outer edge of the flywheel spaced about the edge. A clutch disc is positioned on the driven shaft adjacent the clutch side of the flywheel. The clutch disc includes a plurality of perforations through the clutch disc to increase the airflow through the clutch disc to remove heat. A clutch assembly is operably connected to the clutch disc and flywheel. A bell housing is connected to the engine and enclosing the driven shaft, flywheel, clutch disc and clutch assembly.

### BRIEF DESCRIPTION OF THE DRAWINGS

FIG. 1 is an exploded view of components of a vehicle engine, including an engine block, flywheel, clutch disc, clutch assembly, and bell housing.

FIG. 2 is a plan view of a clutch disc according to the present invention.

FIG. 3 is a perspective view of the clutch disc of FIG. 2 connected to a driven shaft and transmission shaft.

### DETAILED DESCRIPTION OF THE PREFERRED EMBODIMENTS

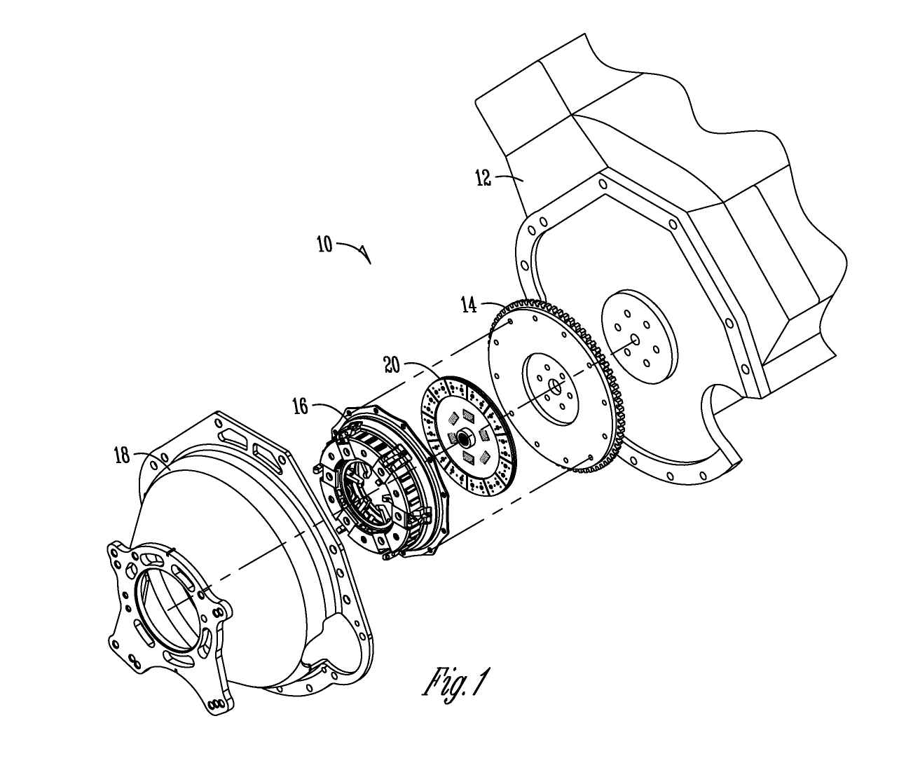

FIG. 1 is an exploded view of a vehicle engine 10, including an engine block 12, a flywheel 14, a clutch disc 20, a clutch assembly 16, and a bell housing 18. The engine block 12 includes a driven shaft extending outwardly from the engine block 12. However, for purposes of the present invention, the crank shaft or driven shaft has been omitted from the figure. The flywheel 14 is mounted on the drive shaft and operably attached to the engine block 12. Adjacent the flywheel 14 is a clutch disc 20. The clutch disc 20 is configured to work with the clutch assembly 16. For example, when the vehicle is in a driving gear, a pressure plate in the clutch assembly 16 presses the clutch disc 20 into engagement with the flywheel 14. The pressure plate may also release the clutch disc 20 from contact with the flywheel 14 when the vehicle is in park, braked, or in an otherwise idle state. Thus, when the clutch disc 20 is in contact with the flywheel 14, the clutch disc 20 and clutch assembly 16 will rotate at the same velocity or rotations per minute (RPM) as the flywheel 14. The bell housing 18 attaches to the engine block 12 and encloses the flywheel 14, clutch disc 20, and clutch assembly 16. The bell housing 18 provides protection from the rotating components of the engine 10.

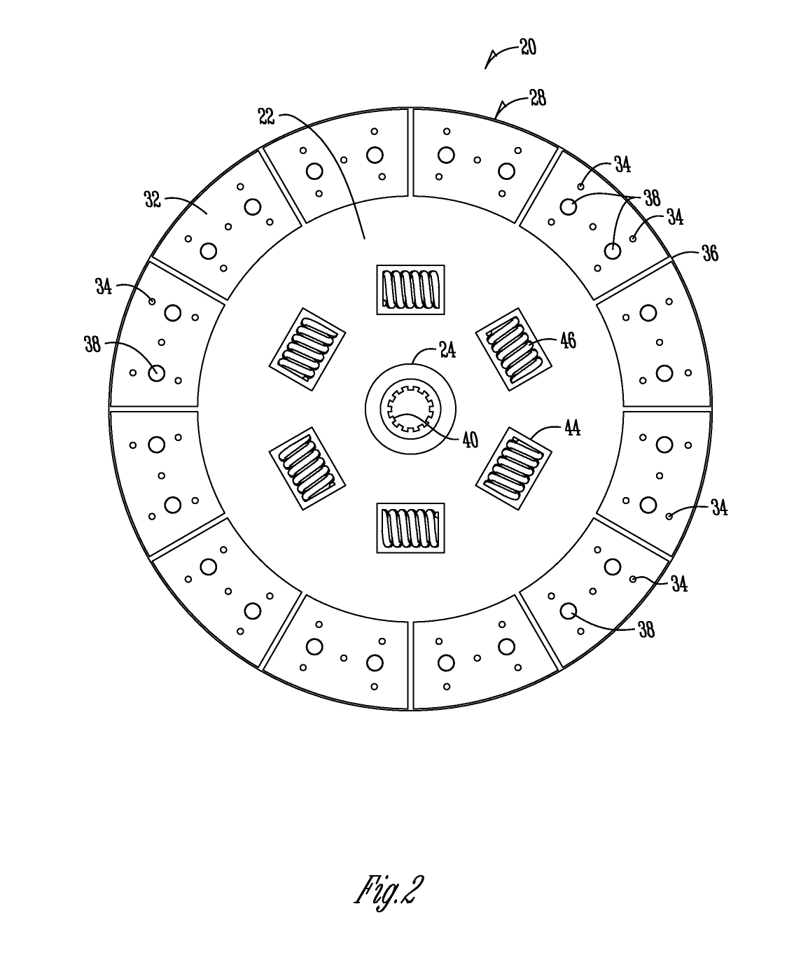

FIG. 2 is a plan view of the clutch disc 20 according to the present invention. The clutch disc 20 comprises a cylindrical disc 22. The cylindrical disc 22 comprises a metal, such as steel. For purposes of the present invention, the cylindrical disc 22 will comprise materials as is known in the art for manufacturing a clutch disc. The clutch disc 20 further includes a central aperture 24 through the clutch disc 20. The central aperture 24 is splined as shown by numeral 40 such that the clutch disc 20 may be mounted on a drive shaft, which is also splined. Furthermore, it should be noted that the central aperture 24 includes an axis 26 therethrough. The axis 26 is aligned with the general axis of the cylindrical disc 22. The cylindrical disc 22 has a flywheel side 28 and an opposite clutch assembly side 30. The flywheel side 28 is configured to be positioned adjacent the flywheel 14 of the engine 10, while the clutch assembly side 30 is configured to be positioned adjacent the clutch assembly 16 of the engine 10. However, it should be noted that the present invention contemplates that the flywheel side 28 and clutch assembly side 30 of the cylindrical disc 22 are mirror images and may be interchangeable for purposes of the invention.

Attached to at least the flywheel side 28 of the cylindrical disc 22 is a clutch lining 32. The clutch lining 32 comprises a material having a high coefficient of friction. The high coefficient of friction is needed for the cylindrical disc 22 to operate with the flywheel 14. For example, the flywheel 14 includes a surface having a rough texture or high coefficient of friction. Thus, when the clutch lining 32 is engaged to the rough texture of the flywheel 14, the flywheel 14 and clutch disc 20 will be engaged such that the disc 20 and flywheel 14 rotate together without substantial slippage. The clutch lining 32 may include a ceramic material, metal material, or other material that is known in the art that has a high coefficient of friction while being strong enough so as not to dissipate or become damaged during normal operations or an automobile. It should also be noted that the present invention contemplates having a clutch lining 32 on one or both sides of the cylindrical disc 22. If the clutch lining 32 is only on one side of the cylindrical disc 22, however, it should be appreciated that the clutch lining 32 will be placed on the flywheel side 28 of the cylindrical disc 22.

The clutch lining 32 is attached to the cylindrical disc 22 near an outer edge or periphery 36 of the cylindrical disc 22. Furthermore, it should be noted that the clutch lining 32 extends towards the central aperture 24 of the cylindrical disc 22 a certain length. The greater the length towards the center of the cylindrical disc 22, the more surface area of clutch lining 32 that the clutch disc 20 has to interact with the flywheel 14. However, it should be noted that the clutch lining 32 will not extend all the way to the central aperture 24 of the cylindrical disc 22. Furthermore, the clutch lining 32 includes bolt holes 38 or other attachment holes. The holes 38 allow the clutch lining 32 to be attached to the cylindrical disc 22. For instance, according to one method of attaching the clutch lining 32 to a cylindrical disc 22, it is contemplated that rivets 42 are used to attach the clutch lining 32 to one or both sides of the cylindrical disc 22. However, the present invention contemplates other methods for attaching the clutch lining 32 to the cylindrical disc 22, and is not limited to rivets.

FIG. 2 also shows a plurality of spring apertures 44 spaced radially about the central aperture 24 of the cylindrical disc 22. Positioned in the spring apertures 44 are a plurality of springs 46 or other dampening means. The springs 46 or other dampening means are used with the clutch disc 20 as is known in the art.

Also shown in FIG. 2 is a plurality of perforations 34. The perforations 34 are positioned through the clutch disc 20, including the clutch lining 32 and the cylindrical disc 22. It should be noted, that if both sides of the cylindrical disc 22 include the clutch lining 32, the perforations 34 will extend through both clutch linings 32 and the cylindrical disc 22. The perforations 34 are not filled with a bolt, rivet, or other connecting means. The perforations 34 are meant as a heat management or cooling system, as will be discussed below. Therefore, the perforations 34 may be machined through the clutch disc 20 once the clutch linings 32 have been attached to the cylindrical disc 22. While FIG. 2 shows a number and shape of perforations 34, it should be noted that the size, shape, orientation, and number of perforations 34 through the clutch disc 20 may be selected by a user depending on the desired output and production. As the clutch disc 20 operates due to friction between the clutch disc 20 and flywheel 14, it should be appreciated that the removal of too much material from the clutch disc 20 may affect the ability of the clutch disc 20 to operate efficiently. Therefore, it is important that the amount of material be removed to create the perforations 34 such that it does not affect the operation efficiency of an automobile engine 10.

As discussed above, the perforations 34 may be machined through the clutch disc 20. For example, the perforations 34 may be milled or otherwise drilled through the clutch disc 20. However, it is contemplated by the present invention that any method is used to remove the material from the clutch lining 32 and cylindrical disc 22 to create the perforations 34 through the clutch disc 20 to still be considered under the present invention.

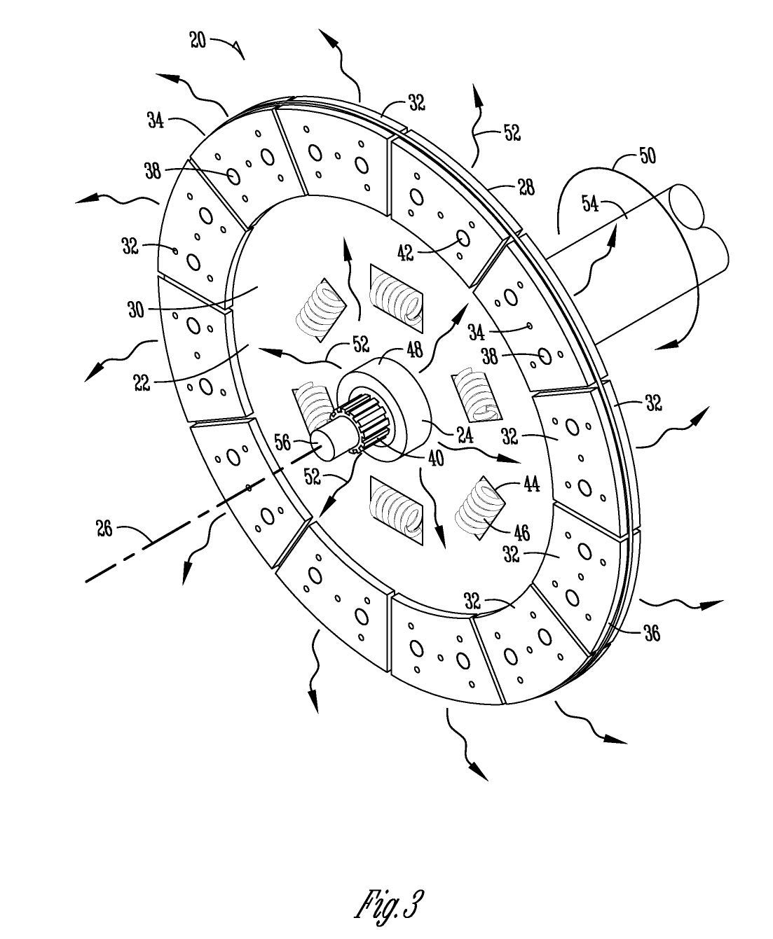

FIG. 3 is a perspective view of the clutch disc 20 of FIG. 2 connected to a driven shaft 54 and transmission shaft 56. As shown generally by arrow 50, the driven shaft 54 will cause the clutch disc 20 to rotate. However, the rotation of the clutch disc 20 and the friction connection between the clutch disc 20 and the flywheel 14 will create excessive heat in the engine 10. The spinning of the clutch disc 20 with the perforations 34 will create a suction effect pulling air from the central area of the clutch disc 20 and outwardly towards the periphery 36 of the clutch disc 20. This is shown generally by the arrows 52 in FIG. 3. Thus, heat will be removed from within the engine 10 and outwardly to an area outside the engine. The removal of heat will increase the life of the clutch disc 20 by delaying the warping or other damage to the clutch disc 20. Furthermore, the perforations 34 to the clutch disc 20 may create airflow through the clutch assembly 16 and flywheel 14 to aid in cooling the other components of the engine 10 as well.

The benefits from including perforations 34 through the clutch disc 20 including through the clutch lining 32 are as follows. The perforations 34 will aid in heat removal by passing air through the perforations 34 into a location outside the internal components of the engine 10. The addition of perforations 34 also has the benefit of not requiring any additional add-ons or additional components to the clutch disc 20. The clutch disc 20 maintains its needed structural integrity in strength and function. In addition, the size, shape, and location of the perforations 34 through the clutch disc 20 are carefully chosen such that the decrease in surface area for contact with the flywheel 14 will be minimal. Thus, normal operation of the engine 10 will continue.

Further components of the clutch disc 20 are shown in FIG. 3. For instance, FIG. 3 shows a flange 48 attached at the central aperture 24 of the cylindrical disc 22. The flange 48 works with the clutch assembly 16. Furthermore, FIG. 3 shows a transmission shaft 56 extending from the clutch assembly side 30 of the clutch disc 20. The transmission shaft 56 will transmit power to the wheels of a vehicle when the clutch disc 20 is in operative communication with the flywheel 14.

The invention has been shown and described above with reference to the preferred embodiments, and it is understood that many modifications, substitutes, and additions may be made that are within the intended spirit and scope of the invention. For example, the size and shape of the clutch disc 20, clutch lining 32, and perforations 34 may be varied according to the automobile used. Alternatively, as discussed above, the number and design of perforations 34 through the clutch disc 20 may also be varied as according to the use. The invention is only to be limited by the claims pended hereto.

What is claimed is:

1. A clutch disc for use in an engine between a clutch assembly and a flywheel, comprising:
a cylindrical disc comprising a central aperture and having a flywheel side comprising a clutch lining having a high coefficient of friction, and a clutch assembly side; and
a plurality of perforations through the cylindrical disc and clutch lining;
wherein the plurality of perforations are designed to increase airflow to remove heat from an area around the central aperture and within the engine.

2. The clutch disc of claim 1 wherein the plurality of apertures are positioned near an outer edge of the clutch disc to aid in the removal of heat from the central aperture area.

3. The clutch disc of claim 1 wherein the central aperture is splined.

4. The clutch disc of claim 1 wherein the cylindrical disc comprises metal.

5. The clutch disc of claim 4 wherein the clutch lining comprises a ceramic material.

6. The clutch disc of claim 5 wherein the lining is attached to the cylindrical disc by rivets.

7. The clutch disc of claim 6 wherein the clutch lining extends from the periphery of the cylindrical disc towards but not reaching the central aperture.

8. The clutch disc of claim 1 wherein the clutch lining is positioned on both the flywheel side and the clutch assembly side of the cylindrical disc.

9. The clutch disc of claim 1 further comprising a plurality of springs positioned through the cylindrical disc and spaced radially about the central aperture.

10. The clutch disc of claim 1 further comprising a flange at the central axis, the flange extending outwardly towards the clutch assembly side of the cylindrical disc.

11. A method of manufacturing a clutch disc, comprising:
providing a generally cylindrical disc having a flywheel side and a clutch assembly side;
machining a splined central aperture through the clutch disc, the central aperture having an axis;
operably attaching a clutch lining having a high coefficient of friction to the flywheel side of the cylindrical clutch disc; and
machining a plurality of perforations through the clutch lining and cylindrical disc about the axis of the central aperture, the plurality of perforations configured to increase the airflow through the clutch disc.

12. The method of claim 11 further comprising operably attaching a clutch lining having a high coefficient of friction to the clutch assembly side of the cylindrical disc.

13. The method of claim 12 wherein the plurality of perforations are machined through the clutch lining on the clutch assembly side of cylindrical disc.

14. The method of claim 11 further comprising machining a plurality of spring apertures through the cylindrical disc adjacent the central aperture and radially positioned about the central aperture.

15. The method of claim 14 further comprising operably attaching a plurality of springs in the plurality of spring apertures.

16. The method of claim 11 further comprising operably attaching a flange to the central aperture of the cylindrical disk.

17. The method of claim 11 wherein the clutch lining extends inwardly from the periphery of the cylindrical disc to a location a distance from the central aperture.

18. The method of claim 11 further comprising the step of determining the location and size of the plurality of perforations that will increase airflow through the clutch disc before machining the perforations.

19. An automobile engine, comprising:
an engine;
a driven shaft extending from the engine;
a flywheel mounted on the driven shaft and including an engine side and a clutch side;
a clutch disc positioned on the driven shaft adjacent the clutch side of the flywheel, the clutch disc including a plurality of perforations through the clutch disc to increase the airflow through the clutch disc to remove heat;
a clutch assembly operably connected to the clutch disc and flywheel; and
a bell housing connected to the engine and enclosing the driven shaft, flywheel, clutch disc and clutch assembly.

20. The automobile of claim 19 wherein the clutch disc comprises a clutch lining on both sides of the clutch disc, and the plurality of perforations formed through the clutch lining.
